(19) United States
(12) Patent Application Publication
(10) Pub. No.: US 2015/0290651 A1
(43) Pub. Date: Oct. 15, 2015

(54) MAGNETIC MILLING SYSTEMS AND METHODS

(71) Applicant: Xerox Corporation, Norwalk, CT (US)

(72) Inventors: Ke Zhou, Mississauga (CA); David John William Lawton, Stoney Creek (CA); Johan Junginger, Toronto (CA); Jun Zhao, Mississauga (CA); Harry P. Latchman, Mississauga (CA); Frank Ping-Hay Lee, Oakville (CA)

(73) Assignee: Xerox Corporation, Norwalk, CT (US)

(21) Appl. No.: 14/249,162

(22) Filed: Apr. 9, 2014

(51) Int. Cl. B02C 17/00; C08K 3/18; C08K 3/32; C08K 3/04

(52) U.S. Cl. CPC B02C 17/005; C08K 3/04; C08K 3/18; C08K 3/32; C08K 2003/327

(57) ABSTRACT

Pigment dispersions are prepared by including magnetic particles in a reaction mixture. When placed in an alternating current magnetic field, milling of pigment particles occurs in the reaction mixture.

### BACKGROUND

The present disclosure relates to systems and methods for magnetic milling. The systems and methods are useful in preparing pigment dispersions that can be used in making toners, inks, electronic displays, liquid crystal displays, organic light-emitting diodes, etc.

A pigment dispersion is an important component used in the preparation of an emulsion aggregation (EA) toner. In order for pigment particles to form aggregates with latex particles, the pigment particles should have a size smaller than or comparable to the size of the latex particles (e.g., from about 5 to about 300 nanometers in diameter). Conventional mechanical impeller mixing systems lose efficiency throughout the whole reaction vessel. For pigment dispersions utilizing an in-line rotor-stator type homogenizer, it generally takes over four hours to homogenize the dispersions. Mechanical components also have drawbacks such as requiring: large amounts of solvent for cleaning; frequent pumping in/out for cleaning pumps/pipelines; and substantial floor space and lack of flexibility.

Furthermore, these systems rely on macro-scale bulk shearing and are not ideal for preparing dispersions having small particles (e.g., submicron particles) such as those of typical pigments used in EA toners.

It would be desirable to provide micro- and/or nano-scale dispersion preparation systems and methods which reduce processing time and cost without sacrificing benchmark material properties (e.g., small particle size and narrow particle size distribution).

### BRIEF DESCRIPTION

The present disclosure discloses various embodiments of systems and methods for preparing dispersions. The systems and methods use magnetic milling via the use of alternating current magnetic fields. It has been found that alternating current magnetic fields provide a very homogeneous pigment dispersion with desirable particles sizes in short processing times.

Disclosed in various embodiments herein are methods for preparing a pigment dispersion, comprising: receiving a mixture comprising pigment particles having a starting D50, a solvent, and magnetic particles; and applying an alternating current magnetic field to the mixture to mill the pigment particles to an ending D50 that is smaller than the starting D50.

The alternating current magnetic field may have a strength of from about 50 to about 2000 milliTesla, or from about 100 to about 1500 milliTesla, or from about 150 to about 1000 milliTesla.

The alternating current magnetic field may be applied at a frequency of from about 3 Hz to about 100 Hz, or from about 40 Hz to about 80 Hz.

The alternating current magnetic field may be applied for a period of about 10 hours or less, or for a period of about 30 minutes or less.

In particular embodiments, the alternating current magnetic field is applied at a strength of from about 150 to about 1000 milliTesla, at a frequency of from about 40 Hz to about 80 Hz, and for a period of about 30 minutes or less.

The mixture may further comprise an anionic surfactant, a cationic surfactant, or a nonionic surfactant.

The alternating current magnetic field can be applied via a solenoid.

The pigment in the pigment dispersion generally has a starting D50 of 180 nanometers or higher. The pigment in the pigment dispersion generally has an ending D50 of less than 180 nanometers, and in particular embodiments an ending D50 of 130±15 nanometers.

The magnetic particles may have an average diameter of from about 2 nanometers to about 10 micrometers. The magnetic particles can be comprised of paramagnetic, ferrimagnetic, ferromagnetic or antiferromagnetic materials. More specifically, the magnetic particles can selected from the group consisting of carbonyl iron particles, Fe, Fe₂O₃, Ni, CrO₂, and Cs.

The solvent can be selected from the group consisting of deionized water, alcohols, ketones, amides, nitriles, ethers, sulfoxides, benzene and benzene derivatives, esters, amines, and combinations thereof.

In particular embodiments, the alternating current magnetic field is applied via a solenoid, and the mixture is continuously flowed past the solenoid.

Also disclosed are methods for preparing a pigment dispersion, comprising: applying an alternating current magnetic field to a mixture for a time period of up to about 10 minutes; wherein the mixture comprises pigment particles, a solvent, a surfactant, and magnetic particles; and wherein the pigment in the pigment dispersion has an ending D50 of 130±15 nanometers.

Also disclosed are methods for preparing a pigment dispersion, comprising: applying an alternating current magnetic field to a mixture for a time period of about 4 minutes to about 6 minutes at a frequency of from 40 Hz to 80 Hz and at a strength of from about 100 to about 300 milliTesla; wherein the mixture comprises pigment particles, deionized water, a surfactant, and carbonyl iron particles; wherein the pigment particles have a D50 of about 130±15 nanometers after the alternating current magnetic field is applied; and wherein the alternating current magnetic field is applied via a solenoid.

These and other non-limiting characteristics of the disclosure are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a diagram of a magnetic actuated mixing system of the present disclosure.

FIG. 2 is a flow chart illustrating an exemplary method for preparing a pigment dispersion in accordance with the present disclosure.

FIG. 3 is an exemplary diagram of a system for continuous preparation of a pigment dispersion.

FIG. 4 is a graph illustrating particle size versus processing time for Comparative Example 1. The y-axis is the D50 of the carbon black particles and is measured in micrometers. The x-axis is the time in hours.

FIG. 5 is a graph illustrating particle size versus processing time for Comparative Example 2. The y-axis is the D50 of the carbon black particles and is measured in micrometers. The x-axis is the time in hours.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

Numerical values should be understood to include numerical values which are the same when reduced to the same number of significant figures and numerical values which differ from the stated value by less than the experimental error of the conventional measurement technique used to determine the value.

The modifier “about” used in connection with a quantity is inclusive of the stated value and has the meaning dictated by the context. When used in the context of a range, the modifier “about” should also be considered as disclosing the range defined by the absolute values of the two endpoints. For example, the range of “from about 2 to about 10” also discloses the range “from 2 to 10.”

As used in the specification, various devices and parts may be described as “comprising” other components. The terms “comprise(s),” “include(s),” “having,” “has,” “can,” “contain(s),” and variants thereof, as used herein, are intended to be open-ended transitional phrases, terms, or words that require the presence of the named component and permit the presence of other components. However, such description should be construed as also describing the devices and parts as “consisting of” and “consisting essentially of” the enumerated components, which allows the presence of only the named component, along with any impurities that might result from the manufacture of the named component, and excludes other components.

Pigment dispersions are often used in the preparation of EA toners. The present disclosure uses magnetic actuated chaotic motion of magnetic particles to prepare pigment dispersions with consistent nano or micro scale shearing throughout the entire vessel, thus providing uniform dispersion of materials within a very short time frame (e.g., minutes). The methods of the present disclosure reduce the need for complex layouts of pipes, pumps, impellers, and material transfer commonly required for the preparation of pigment dispersions. Moreover, the present methods are generic for any type or geometry design of reaction vessels, and can be readily optimized to fit any set up.

More specifically, pigment dispersions are formed by combining pigment particles with magnetic particles in a reaction mixture. The pigment particles have a starting particle size that is generally larger than desired. When the reaction mixture is placed in a magnetic field that is generated by an alternating current, the magnetic particles move throughout the reaction mixture, shearing and milling the pigment particles down

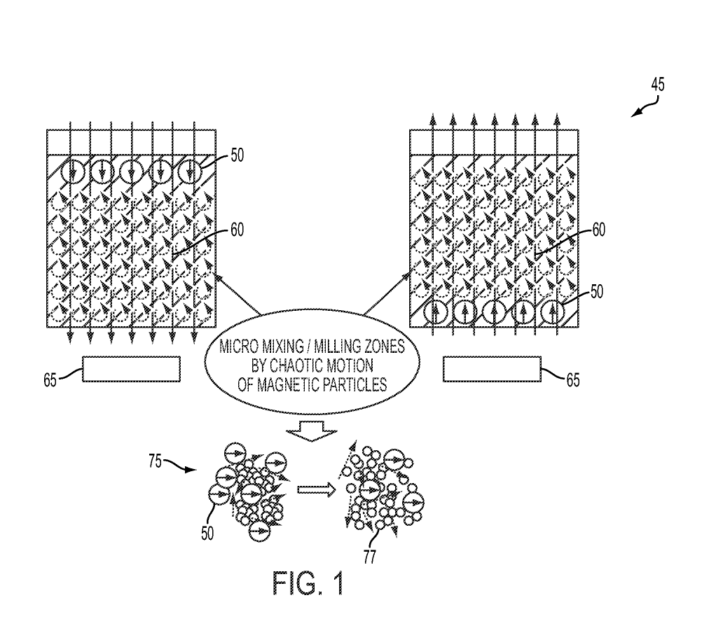

As shown in FIG. 1, there is provided a milling system 45 comprising magnetic particles 50 loaded in a solution, which are moved to mill down pigment particles 77 by an alternating current magnetic field 60 applied to the magnetic particles 50. The magnetic particles may be pre-loaded or filled into the vessel 70 when milling is needed. The magnetic field 60 is applied through an alternating current magnetic field source 65 (e.g., a solenoid) adjacent to vessel 70. The system 45 achieves intense micro shearing fields 75 uniformly on the pigment particles throughout the vessel 70. The magnetic particles 50 under the varying magnetic field impact on the pigment particles 77, reducing their size. The magnetic particles can later be successfully collected and recycled by a magnet for subsequent applications.

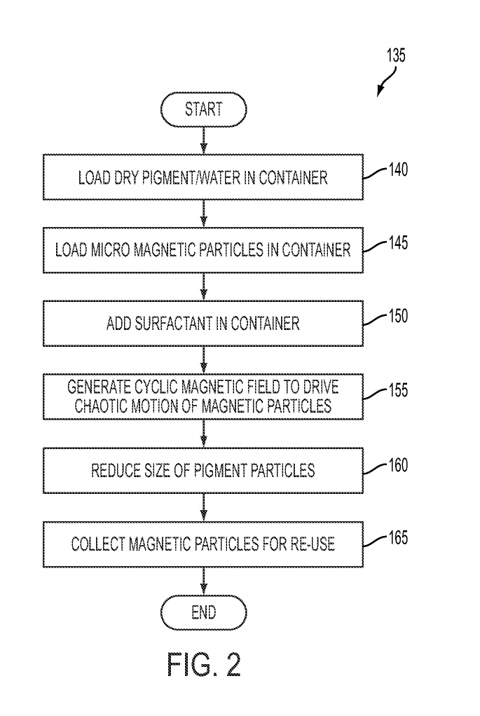

In embodiments, there is provided a method for preparing pigment dispersions using magnetic actuated mixing 135 as shown in FIG. 2. Initially a reaction mixture is formed. A dry pigment is loaded along with a solvent into the vessel at step 140.

The pigment can be selected from the group consisting of a blue pigment, a black pigment, a cyan pigment, a brown pigment, a green pigment, a white pigment, a violet pigment, a magenta pigment, a red pigment, an orange pigment, a yellow pigment, and mixtures thereof. In one embodiment, the pigment is carbon black.

The solvent can be water, or any suitable organic solvent. Suitable organic solvents for the methods disclosed herein include alcohols, such as methanol, ethanol, isopropanol, butanol, as well as higher homologs and polyols, such as ethylene glycol, glycerol, sorbitol, and the like; ketones, such as acetone, 2-butanone, 2-pentanone, 3-pentanone, ethyl isopropyl ketone, methyl isobutyl ketone, diisobutyl ketone, and the like; amides, such as dimethylformamide, dimethylacetamide, N-methylpyrrolidone, 1,2-dimethyl-2-imidazolidinone, and the like; nitriles, such as acetonitrile, propionitrile, butyronitrile, isobutyronitrile, valeronitrile, benzonitrile, and the like; ethers, such as ditertbutyl ether, dimethoxyethane, 2-methoxyethyl ether, 1,4-dioxane, tetrahydrohyran, morpholine, and the like; sulfones, such as methylsulfonylmethane, sulfolane, and the like; sulfoxides, such as dimethylsulfoxide; phosphoramides, such as hexamethylphosphoramide; benzene and benzene derivatives; as well as esters, amines and combinations thereof.

In embodiments, the pigment/solvent mixture comprises the pigment and solvent in a weight ratio of from about 1% to about 99%, or from about 5% to about 80%, or from about 10% to about 50%, or from about 15% to about 25%. The pigment particles at this stage (prior to milling) have a starting D₅₀ of 180 nanometers or higher. The particle diameter at which a cumulative percentage of 50% (by number) of the total number of particles are attained is defined as the D₅₀. In other words, 50% of the particles have a diameter above the D₅₀, and 50% of the particles have a diameter below the D₅₀.

Next, the magnetic particles are loaded into the vessel at step 145. The magnetic particles may be comprised of paramagnetic, ferrimagnetic, ferromagnetic or antiferromagnetic materials, such as Fe, Fe₂O₃, Ni, CrO₂, Cs, and the like or mixtures thereof. In particular embodiments, the magnetic particles are carbonyl iron particles or are Fe₂O₃ particles. Carbonyl iron particles are prepared by the decomposition of iron pentacarbonyl, and are very pure iron (97.5% Fe or higher), with most of the impurities being carbon, oxygen, or nitrogen. If desired, the magnetic particles can have a non-magnetic coating, which may be helpful in preventing unplanned reactions with the other ingredients in the dispersion. For example, the magnetic particles can be encapsulated with a shell, such as a polymeric shell made from polystyrene, polyvinyl chloride, TEFLON®, PMMA, and the like and mixtures thereof.

The magnetic particles may have a diameter of from about 5 nanometers (nm) to about 50 micrometers (μm), or from about 10 nm to about 10 μm, or from about 100 nm to about 5 μm, or in particular embodiments from about 2 nm to about 10 μm. In some embodiments, the magnetic particles are larger than the pigment particles in the dispersion (e.g., 2 times larger than, 10 times larger than, 20 times larger than, or 100 times larger than). Such sizing allows the magnetic particles to be filtered out after the milling has occurred.

The volume percentage of magnetic particles can be chosen based on different applications or processes. In embodiments, the volume percentage of magnetic particles used for milling may also vary depending on the different application or process for which the pigment particles are being used. For example, from about 5 vol % to about 80 vol %, or from about 10 vol % to about 50 vol %, or from about 25 vol % to about 45 vol % magnetic particles may be added to the vessel. The volume percentage is based on the total size of the vessel in which the mixture is formed, not the volume of solvent in the mixture.

A surfactant may then be added to the pigment/water mixture in the vessel at step 150 to complete formation of the reaction mixture. The surfactant is optional. In embodiments, the surfactant is selected from the group consisting of anionic surfactants, nonionic surfactants, cationic surfactants, and combinations thereof. In specific embodiments, the surfactant used herein is TAYCA POWER surfactant, which are generally dodecylbenzene sulfonates or dodecylbenzene sulfonic acids offered commercially by Tayca Corporation.

Anionic surfactants that can be used include sulfates and sulfonates, sodium dodecylsulfate (SDS), sodium dodecylbenzene sulfonate, sodium dodecylnaphthalene sulfate, dialkyl benzenealkyl sulfates and sulfonates, acids such as abietic acid available from Aldrich, NEOGEN®, NEOGEN SC™ obtained from Daiichi Kogyo Seiyaku Co., Ltd., combinations thereof, and the like. Other suitable anionic surfactants include, DOWFAX™ 2 A1, an alkyldiphenyloxide disulfonate from The Dow Chemical Company, and/or TAYCA POWER BN2060 from Tayca Corporation (Japan), which are branched sodium dodecyl benzene sulfonates. Combinations of these surfactants and any of the foregoing anionic surfactants can be used.

Examples of cationic surfactants include, but are not limited to, ammoniums, for example, alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, C12, C15, C17 trimethyl ammonium bromides, combinations thereof, and the like. Other cationic surfactants include cetyl pyridinium bromide, halide salts of quaternized polyoxyethylalkylamines, dodecylbenzyl triethyl ammonium chloride, MIRAPOL and ALKAQUAT available from Alkaril Chemical Company, SANISOL (benzalkonium chloride), available from Kao Chemicals, combinations thereof, and the like. A suitable cationic surfactant includes SANISOL B-50 available from Kao Corp., which is primarily a benzyl dimethyl alkonium chloride.

Examples of nonionic surfactants include, but are not limited to, alcohols, acids and ethers, for example, polyvinyl alcohol, polyacrylic acid, methalose, methyl cellulose, ethyl cellulose, propyl cellulose, hydroxyl ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy) ethanol, combinations thereof, and the like. Commercially available surfactants from Rhone-Poulenc such as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX 890™ and ANTAROX 897™ can be used.

One, two, or more surfactants can be used. The choice of particular surfactants or combinations thereof, as well as the amounts of each to be used, are within the purview of those skilled in the art.

It should be noted that the ingredients of the reaction mixture can be added in any order, i.e. steps 140, 145, and 150 can be performed in any order. After the reaction mixture is formed in the vessel, an alternating current magnetic field is generated and applied to the reaction mixture at step 155. A pigment dispersion with the desired particle size is then achieved by continued mixing of the magnetic particles through application of the alternating current magnetic field. A reduction in pigment particle size is achieved with continued mixing, and is marked as step 160. The magnetic particles can then be collected for re-use at step 165.

The alternating current magnetic field can be generated through an appropriate device, such as a solenoid. The direction in which the magnetic field is applied is not particularly significant, so long as the magnetic particles are able to travel through the reaction mixture.

The alternating current magnetic field may have a strength of about 50 to about 2000 milliTesla (mT), or from about 100 to about 1500 mT, or from about 150 to about 1000 mT. The alternating current magnetic field may operate at a frequency of from about 3 Hz to about 100 Hz, or from about 40 Hz to about 80 Hz. In this regard, it is noted that if the frequency is too great, then the magnetic particles will have insufficient time to circulate through the reaction mixture and mill the pigment particles. The duration of magnetic mixing will be dependent on the pigment particle size desired. In embodiments, the alternating current magnetic field is applied for a period of about 10 hours or less, including about 1 hour or less. In even more desired embodiments, the alternating current magnetic field is applied for a period of about 3 hours or less, or a period of about 30 minutes or less, or a period of about 10 minutes or less, or a period of about 5 minutes or less.

In particular embodiments, the alternating current magnetic field is applied at a strength of about 150 to about 1000 mT, at a frequency of about 40 Hz to about 80 Hz, and for a period of 30 out 10 minutes or less.

After the magnetic mixing is completed, the pigment particles will have been milled to a smaller particle size. In particular embodiments, the pigment particles have an ending D50 of about 100 nm to about 150 nm, or 130±15 nanometers.

The alternating current magnetic field used in the present disclosure is able to drive chaotic or random motion of magnetic particles across the whole solution at a micro scale. This type of random motion generates maximized shearing and impacting effects on the pigment particles and helps facilitate a uniform milling of the materials to achieve the desired particle size.

The present methods and systems disclosed herein require significantly fewer mechanical components and thus less maintenance, which significantly reduces the cost of the system. The systems, due to their use of magnetic fields, are also quiet, reducing noise and volume in a production environment.

The magnetic milling methods disclosed herein may be used in a batch process or a continuous process. Batch processes are typically used to form a desired quantity of a fluid. The batch process may be performed in a closed vessel (e.g., a glass vial).

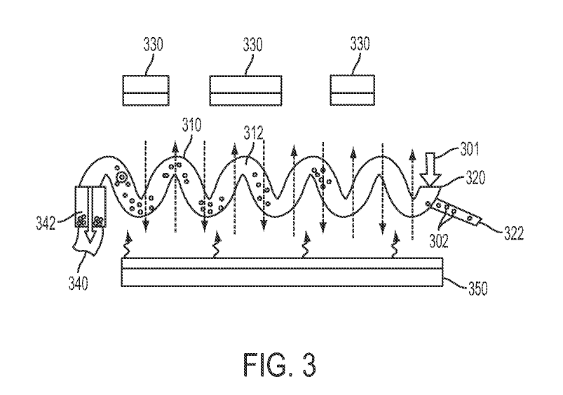

In continuous processes, the materials are typically processed in constant motion (subject to infrequent maintenance shutdowns). The continuous processes of the present disclosure may be performed by flowing a mixture through a mixing tube while one or more alternating current magnetic field sources are located adjacent to the tube. An example of such a system is presented in FIG. 3. The system includes a mixing tube 310. The mixing tube can be of any desired shape, and is shown here as a coil, which permits increased tube length for milling in a smaller footprint.

The mixing tube may include one or more inlets. In some embodiments, the mixing tube includes separate inlets for the solvent, pigment particles, magnetic particles, and optional surfactant. As illustrated here, the solvent, pigment particles, and optional surfactant (large arrow 301) are fed to the mixing tube via a first inlet 320 and the magnetic particles 302 are fed to the mixing tube via a second inlet 322. The second inlet may be located downstream of the first inlet. In some embodiments, the inlet(s) is/are located upstream of a mixing zone 312 of the mixing tube.

The system for performing the continuous process may include a plurality (e.g., 2, 3, 4, or more) of magnetic field sources 330 and a controller (not shown) configured to activate the plurality of sources. Here, three alternating current magnetic field sources are illustrated, and dashed arrows indicate the magnetic field. The controller may be configured to activate the sources in sync or out of sync. The one or more alternating current magnetic field sources may be in the form of coils located adjacent at least a portion of the mixing tube. The mixing zone is the portion of the mixing tube where the alternating current magnetic field source(s) is configured to act upon.

As the mixture flows through the mixing tube, the generated alternating current magnetic field acts upon the magnetic particles, thereby increasing flow turbulence and mixing the components of the mixture to generate the dispersion. To further increase the mixing performance of the mixing tube, the shape of the mixing tube may deviate from being straight. In some embodiments, as shown here, the mixing tube is coiled. One or more obstructions may be added to a flow path through the mixing tube in order to increase turbulent flow. The dispersion is then obtained at the outlet 340. The particles can be removed or filtered from the dispersion by passing through a collector 342. The collector may be, for example, a mesh filter having openings smaller than the diameter of the magnetic particles. Alternatively, the collector could be a magnet for capturing the magnetic particles, or could be a centrifugal filter that captures the magnetic particles using a centrifugation process, so long as undue separation of the pigment dispersion does not occur.

Other elements that improve mixing of the dispersion may also be included within the continuous processing system. For example, FIG. 3 also depicts a heating and/or cooling structure 350 that provides a heating and/or cooling zone. The heating and/or cooling structure may be an electric heater/cooler, a blower, etc. having an output (solid arrows depicting the output) that changes the temperature of the dispersion within the mixing tube 310. Heating the dispersion may be useful in decreasing its viscosity within the mixing tube or increasing the speed of a chemical reaction between the components within the mixing tube. Cooling the dispersion may be useful in increasing the viscosity of the dispersion within the mixing tube or decreasing the speed of a chemical reaction between components within the mixing tube.

Suitable pigments for processing using the methods of the present disclosure include those comprising carbon black, such as, REGAL 330® and Nipex 35. Colored pigments, such as, cyan, magenta, yellow, red, orange, green, brown, blue or mixtures thereof can be used. The additional pigment or pigments can be used as water-based pigment dispersions.

Suitable colorants include inorganic pigments and organic pigments. Examples of pigments include SUNSPERSE 6000, FLEXIVERSE and AQUATONE, water-based pigment dispersions from SUN Chemicals; HELIOGEN BLUE L6900™, D6840™, D7080™, D7020™, PYLAM OIL BLUE™, PYLAM OIL YELLOW™ and PIGMENT BLUE I™ available from Paul Uhlich & Company, Inc.; PIGMENT VIOLET I™, PIGMENT RED 48™, LEMON CHROME YELLOW DCC IO26™, TOLUIDINE RED™ and BON RED C™ available from Dominion Color Corporation, Ltd., Toronto, Ontario; NOVAPERM YELLOW FGL™ and HOSTAPERM PINK E™ from Hoechst; CINQUASIA MAGENTA™ available from E.I. DuPont de Nemours & Co., and the like.

Examples of magenta pigments include 2,9-dimethyl-substituted quinacridone, an anthraquinone dye identified in the Color Index as CI 60710, CI Dispersed Red 15, a diazo dye identified in the Color Index as CI 26050, CI Solvent Red 19 and the like.

Illustrative examples of cyan pigments include copper tetra(octadecylsulfonamido) phthalocyanine, a copper phthalocyanine pigment listed in the Color Index as CI 74160, CI Pigment Blue, Pigment Blue 15:3, Pigment Blue 15:4, an Anthrazine Blue identified in the Color Index as CI 69810, Special Blue X-2137 and the like.

Illustrative examples of yellow pigments are diarylide yellow 3,3-dichlorobenzidene acetoacetanilide, a monoazo pigment identified in the Color Index as CI 12700, CI Solvent Yellow 16, a nitrophenyl amine sulfonamide identified in the Color Index as Foron Yellow SE/GLN, CI Disperse Yellow 3,2,5-dimethoxy-4-sulfonanilide phenylazo-4′-chloro-2,5-dimethoxy acetoacetanilide and Permanent Yellow FGL.

Examples of inorganic pigments include Ultramarine violet: (PV15) Silicate of sodium and aluminum containing sulfur; Han Purple: BaCuSi₂O₆; Cobalt Violet: (PV14) cobalt phosphate; Manganese Violet: (PV16) Manganese ammonium phosphate; Ultramarine (PB29): a complex naturally occurring pigment of sulfur-containing sodio-silicate (Na₈₋₁₀Al₆Si₆O₂₄S₂₋₄); Cobalt Blue (PB28) and Cerulean Blue (PB35): cobalt(II) stannate; Egyptian Blue: a synthetic pigment of calcium copper silicate (CaCuSi₄O₁₀); Han Blue: BaCuSi₄O₁₀; Prussian Blue (PB27): a synthetic pigment of ferric hexacyanoferrate (Fe₇(CN)₁₈). The dye Marking blue is made by mixing Prussian Blue and alcohol; YIn₁₋ₓMnₓO₃: a synthetic pigment made from inserting Mn into the trigonal bipyramidal atomic site of the YInO₃ crystal structure. Cadmium Green: a light green pigment consisting of a mixture of Cadmium Yellow (CdS) and Viridian (Cr₂O₃); Chrome Green (PG17); Viridian (PG18): a dark green pigment of hydrated chromium(III) oxide (Cr₂O₃); Paris Green: copper(II) acetoarsenite; (Cu(C₂H₃O₂)₂.3Cu(AsO₂)₂); Scheele's Green (also called Schloss Green): copper arsenite CuHAsO₃; Orpiment natural monoclinic arsenic sulfide (As₂S₃); Cadmium Yellow (PY37): cadmium sulfide (CdS); Chrome Yellow (PY34): natural pigment of lead(II) chromate (PbCrO₄); Aureolin (also called Cobalt Yellow) (PY40): Potassium cobaltinitrite (Na₃Co(NO₂)₆; Yellow Ochre (PY43): a naturally occurring clay of hydrated iron oxide (Fe₂O₃.H₂O); Naples Yellow (PY41); Titanium Yellow (PY53); Mosaic gold: stannic sulfide (SnS₂); Cadmium Orange (PO20): an intermediate between cadmium red and cadmium yellow: cadmium sulfoselenide; Chrome Orange: a naturally occurring pigment mixture composed of lead(II) chromate and lead(II) oxide. (PbCrO₄+PbO); Cadmium Red (PR108): cadmium selenide (CdSe); Sanguine, Caput Mortuum, Venetian Red, Oxide Red (PR102); Burnt Sienna (PBr7): a pigment produced by heating Raw Sienna; Carbon Black (PBk7); Ivory Black (PBk9); Vine Black (PBk8); Lamp Black (PBk6); Titanium Black; Antimony White: Sb₂O₃; Barium sulfate (PW5); Titanium White (PW6): titanium(IV) oxide TiO₂; Zinc White (PW4): Zinc Oxide (ZnO)

Other known colorants can be used, such as, Levanyl Black A-SF (Miles, Bayer) and Sunsperse Carbon Black LHD 9303 (Sun Chemicals), and colored dyes, such as, Neopen Blue (BASF), Sudan Blue OS (BASF), PV Fast Blue B2G 01 (American Hoechst), Sunsperse Blue BHD 6000 (Sun Chemicals), Irgalite Blue BCA (CibaGeigy), Paliogen Blue 6470 (BASF), Sudan III (Matheson, Coleman, Bell), Sudan II (Matheson, Coleman, Bell), Sudan IV (Matheson, Coleman, Bell), Sudan Orange G (Aldrich), Sudan Orange 220 (BASF), Paliogen Orange 3040 (BASF), Ortho Orange OR 2673 (Paul Uhlich), Paliogen Yellow 152, 1560 (BASF), Lithol Fast Yellow 0991K (BASF), Paliotol Yellow 1840 (BASF), Neopen Yellow (BASF), Novoperm Yellow FG 1 (Hoechst), Permanent Yellow YE 0305 (Paul Uhlich), Lumogen Yellow D0790 (BASF), Sunsperse Yellow YHD 6001 (Sun Chemicals), Suco-Gelb L1250 (BASF), SUCD-Yellow D1355 (BASF), Hostaperm Pink E (American Hoechst), Fanal Pink D4830 (BASF), Cinquasia Magenta (DuPont), Lithol Scarlet D3700 (BASF), Toluidine Red (Aldrich), Scarlet for Thermoplast NSD PS PA (Ugine Kuhlmann of Canada), E.D. Toluidine Red (Aldrich), Lithol Rubine Toner (Paul Uhlich), Lithol Scarlet 4440 (BASF), Bon Red C (Dominion Color Company), Royal Brilliant Red RD-8192 (Paul Uhlich), Oracet Pink RF (Ciba-Geigy), Paliogen Red 3871 K (BASF), Paliogen Red 3340 (BASF), Lithol Fast Scarlet L4300 (BASF), combinations of the foregoing and the like. Other pigments that can be used, and which are commercially available include various pigments in the color classes, Pigment Yellow 74, Pigment Yellow 14, Pigment Yellow 83, Pigment Orange 34, Pigment Red 238, Pigment Red 122, Pigment Red 48:1, Pigment Red 269, Pigment Red 53:1, Pigment Red 57:1, Pigment Red 83:1, Pigment Violet 23, Pigment Green 7 and so on, and combinations thereof.

The following examples are for purposes of further illustrating the present disclosure. The examples are merely illustrative and are not intended to limit devices made in accordance with the disclosure to the materials, conditions, or process parameters set forth therein. All parts are percentages by weight unless otherwise indicated.

### EXAMPLES

### Comparative Example 1

A mixture was added to a 9 milliliter (mL) glass vial. The mixture included 0.34 grams of carbon black pigment pigment powder (Regal 330), 1.26 grams of deionized water (DIW), 0.18 grams (18.75 wt %) TAYCA POWER surfactant, and 3.4 mL of 5 micron carbonyl iron.

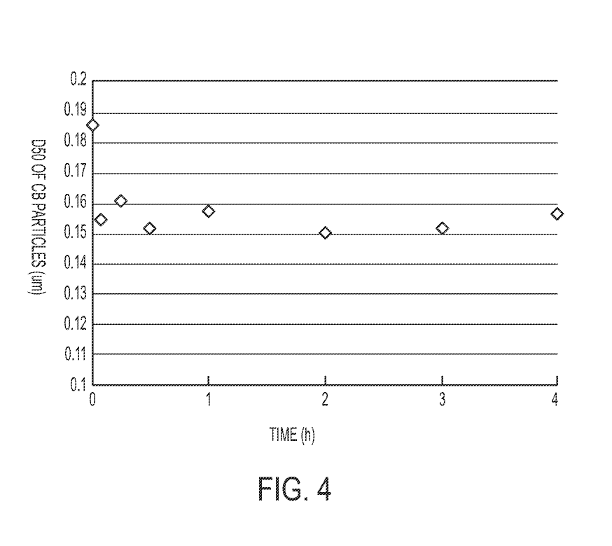

The vial containing the mixture was placed under a direct current electromagnetic field generated by two electromagnets (i.e., a top magnet and a bottom magnet on opposing sides of the vial). The maximum magnetic field strength was 90 milliTesla. The direction of the electromagnetic field was changed by alternatively turning on and off the magnets, with the top magnet being activated for 200 milliseconds, then turned off and the bottom magnet being activated for 100 milliseconds, and repeating this pattern. The particle size of the carbon black pigment particles was measured over time. FIG. 4 is a graph showing the D₅₀ of the carbon black particles as a function of time. A significant particle size decrease occurred during the first five (5) minutes. However, no further particle size reduction occurred after 4 hours, resulting in a final particle pigment size of 150-160 nanometers. A stronger magnetic field would be required to achieve a target particle size of 130±15 nanometers.

### Comparative Example 2

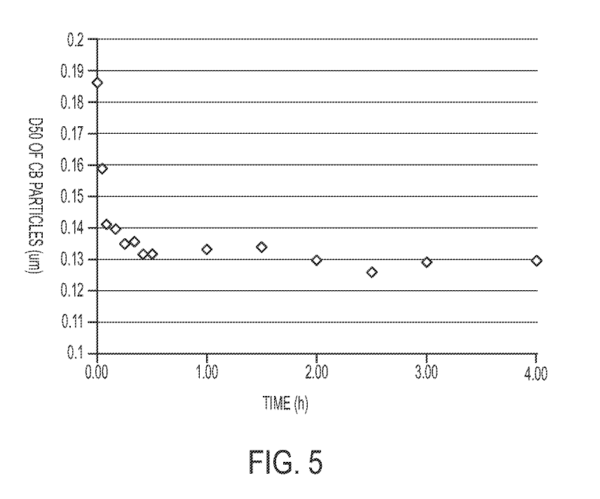

A mixture was added to a 9 milliliter glass vial. The mixture included 0.85 grams of carbon black pigment powder (Regal 330), 1.37 grams of DIW, 0.45 grams (18.75 wt %) TAYCA POWER, and 2.62 milliliters of 5 micron carbonyl iron. A permanent magnet having a magnetic field of about 400 milliTesla was placed adjacent to the vial containing the mixture. The vial was rotated via an agitator at a rate of approximately 400 revolutions per minute. The particle size of the carbon black pigment particles was measured over time. FIG. 5 is a graph showing the D₅₀ of the carbon black particles as a function of time. FIG. 5 shows that a majority of the particle size decrease happened within 5 minutes, with the final particle size of 130 nanometers being achieved after 30 minutes. Additional stirring did not further reduce the particle size.

### Examples 1-4

A mixture was added to a 5 milliliter glass vial. The mixture included 0.2 grams of carbon black pigment powder (Regal 330), 0.74 grams of DIW, 0.11 grams (18.75 wt %) TAYCA POWER surfactant, and 2 milliliters of 5 micron carbonyl iron. The vial containing the mixture was put under an alternating current electromagnetic field generated by a solenoid. The electromagnetic field was generated at 200 milliTesla with a frequency of 60 hertz. The particle size of the pigment was measured after 5 minutes. The same procedure was performed 3 more times. Table 1 (below) shows the results of Examples 1-4.

| Example No. | Magnetic Field | D₅₀ (nanometers) |
|---|---|---|
| 1 | 200 milliTesla, 5 minutes | 139.5 |
| 2 | 200 milliTesla, 5 minutes | 141.3 |
| 3 | 200 milliTesla, 5 minutes | 140.0 |
| 4 | 200 milliTesla, 5 minutes | 143.7 |

Table 1 shows that an alternating current field can provide a desired particle size in a very short period of time (e.g., about 5 minutes).

In contrast, it took about 2 hours to achieve the desired particle size in a pilot plant utilizing a conventional homogenization process.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A method for preparing a pigment dispersion, comprising:
receiving a mixture comprising pigment particles having a starting D₅₀, a solvent, and magnetic particles; and
applying an alternating current magnetic field to the mixture to mill the pigment particles to an ending D₅₀ that is smaller than the starting D₅₀.

2. The method of claim 1, wherein the alternating current magnetic field has a strength of from about 50 to about 2000 milliTesla.

3. The method of claim 1, wherein the alternating current magnetic field has a strength of from about 100 to about 1500 milliTesla.

4. The method of claim 1, wherein the alternating current magnetic field has a strength of from about 150 to about 1000 milliTesla.

5. The method of claim 1, wherein the alternating current magnetic field is applied at a frequency of from about 3 Hz to about 100 Hz.

6. The method of claim 1, wherein the alternating current magnetic field is applied at a frequency of from about 40 Hz to about 80 Hz.

7. The method of claim 1, wherein the alternating current magnetic field is applied for a period of about 10 hours or less.

8. The method of claim 1, wherein the alternating current magnetic field is applied for a period of about 30 minutes or less.

9. The method of claim 1, wherein the alternating current magnetic field is applied at a strength of from about 150 to about 1000 milliTesla, at a frequency of from about 40 Hz to about 80 Hz, and for a period of about 30 minutes or less.

10. The method of claim 1, wherein the mixture further comprises an anionic surfactant, a cationic surfactant, or a nonionic surfactant.

11. The method of claim 1, wherein the alternating current magnetic field is applied via a solenoid.

12. The method of claim 1, wherein the pigment in the pigment dispersion has a starting D₅₀ of 180 nanometers or higher.

13. The method of claim 1, wherein the pigment in the pigment dispersion has an ending D₅₀ of less than 180 nanometers.

14. The method of claim 1, wherein the pigment in the pigment dispersion has an ending D₅₀ of 130±15 nanometers.

15. The method of claim 1, wherein the magnetic particles have an average diameter of from about 2 nanometers to about 10 micrometers.

16. The method of claim 1, wherein the magnetic particles are comprised of paramagnetic, ferrimagnetic, ferromagnetic or antiferromagnetic materials; or wherein the magnetic particles are selected from the group consisting of carbonyl iron particles, Fe, Fe₂O₃, Ni, CrO₂, and Cs.

17. The method of claim 1, wherein the solvent is selected from the group consisting of deionized water, alcohols, ketones, amides, nitriles, ethers, sulfoxides, benzene and benzene derivatives, esters, amines, and combinations thereof.

18. The method of claim 1, wherein the alternating current magnetic field is applied via a solenoid, and wherein the mixture is continuously flowed past the solenoid.

19. A method for preparing a pigment dispersion, comprising:
applying an alternating current magnetic field to a mixture for a time period of up to about 10 minutes;
wherein the mixture comprises pigment particles, a solvent, a surfactant, and magnetic particles; and
wherein the pigment in the pigment dispersion has an ending D₅₀ of 130±15 nanometers.

20. A method for preparing a pigment dispersion, comprising:
applying an alternating current magnetic field to a mixture for a time period of about 4 minutes to about 6 minutes at a frequency of from 40 Hz to 80 Hz and at a strength of from about 100 to about 300 milliTesla;
wherein the mixture comprises pigment particles, deionized water, a surfactant, and carbonyl iron particles;
wherein the pigment particles have a D₅₀ of about 130±15 nanometers after the alternating current magnetic field is applied; and
wherein the alternating current magnetic field is applied via a solenoid.
